(19) United States
(12) Patent Application Publication
(10) Pub. No.: US 2015/0138365 A1
(43) Pub. Date: May 21, 2015

(54) NETWORK VIDEO MONITORING SYSTEM AND METHOD FOR AUTOMATICALLY ASSIGNING CAMERAS IN THE SAME

(71) Applicant: Delta Electronics, Inc., Taoyuan County (TW)

(72) Inventors: Tung-Yi HSIEH, Taoyuan County (TW); Chia-Ching CHAN, Taoyuan County (TW)

(73) Assignee: Delta Electronics, Inc., Taoyuan County (TW)

(21) Appl. No.: 14/227,619

(22) Filed: Mar. 27, 2014

(30) Foreign Application Priority Data
Nov. 18, 2013 (TW) 102141859

(51) Int. Cl. H04N 7/18; H04L 12/24; H04L 29/08

(52) U.S. Cl. CPC H04N 7/181; H04L 67/12; H04L 41/08
USPC 348/159

(57) ABSTRACT

A network video monitoring system includes a core-control module, a plurality of network video recording (NVR) hosts, and a plurality of cameras. The core-control module assigns the cameras to the NVR hosts respectively for controlling the camera by the NVR hosts according to status of each NVR host. In this application, the core-control module obtains the status of each NVR host periodicity for determining if the NVR hosts are over loading or failed, and re-assigns the cameras automatically for the overloaded or malfunctioned NVR hosts. The application rescues the NVR hosts from the over loading problem, and prevents the termination of the monitoring action of the cameras when one of the NVR host malfunctions.

### BACKGROUND OF THE INVENTION

1. Field of the Invention

The present invention relates to monitoring system, especially to network video monitoring system and automatic assignment method for the monitoring system.

2. Description of Related Art

In a monitoring system, cameras generally only fetch locale image, and therefore, the cameras are controlled by a rear-end host to fetch image and store the fetched image. Moreover, user of the system generally views the monitored image of the camera and plays back the recorded file through operating the host.

FIG. 14 shows a related art monitoring system, which comprises a plurality of network video recording (NVR) hosts 6, a network switch 7 and a plurality of cameras 8. The NVR hosts 6 are connected to the network switch 7 and further connected to the cameras 8 through the network switch 7.

The monitoring system needs lots of NVR hosts 6 to control the monitoring and recording tasks of the cameras respectively when a lots of cameras 8 (namely, image sources) are deployed in the monitoring system. When the user want to view the monitoring image of the target NVR host or fetch the stored image file, the user generally sends request to a target camera by a user terminal 9, which further relays the request to the NVR host 6 through Internet.

However, in the related art monitoring system, the NVR hosts 6 operates independently. The system manager needs to set up the NVR hosts 6 individually such that the NVR 6 can be assigned to control the cameras 8 respectively. When a NVR host 6 is overloaded, the system manager also needs to manually transfer the control right of the overloaded NVR host over cameras 8 to another NVR host 6. In other words, the related art monitoring system cannot automatically conduct the transfer of control right. Moreover, when a NVR host 6 malfunctions, the system manager also needs to manually fix the problem because the related art monitoring system cannot automatically fix the problem.

Moreover, when a NVR host 6 malfunctions, the cameras 8 originally controlled by the malfunctioned NVR host 6 stops monitoring and recording operation. The image taken by above cameras 8 cannot be stored or recovered unless the malfunctioned NVR host 6 is fixed. The user also cannot view the instant image taken by the camera 8 if it is controlled by an unrepaired and malfunctioned NVR host 6.

Moreover, due to the independency of the NVR hosts 6, all of the NVR hosts 6 need to connect to Internet to render the user viewing the image of the camera through Internet. The NVR hosts 6 in related art monitoring have public IP address and are vulnerable to Internet hacker.

Accordingly, it is desirable to develop a novel monitoring system with ease for system manager to manage the overloaded and/or malfunctioned NVR host, and with less risk of hacker attack.

### SUMMARY OF THE INVENTION

It is an object of the present invention to provide a network video monitoring system and related method, where the cameras can be dynamically assigned to corresponding NVR host according to the statuses of NVR hosts and quality of the camera, whereby the loading of the NVR hosts can be balanced.

It is another object of the present invention to provide a network video monitoring system and related method, where the control right over the cameras controlled by a malfunctioned NVR host can be dynamically transferred to another NVR host, which has normal operation. Therefore, the operation of the camera will not be affected by the malfunctioned NVR host.

Accordingly, the present invention provides a network video monitoring system, which comprises a core-control module, a plurality of network video recording (NVR) hosts and a plurality of cameras. The NVR hosts are operatively connected to the core-control module, and the core-control module assigns the cameras to the respective NVR hosts according to the statuses of the NVR hosts. The core-control module periodically inquires the status of each NVR host to determine whether overloaded NVR host and/or malfunctioned NVR host exist. The core-control module dynamically changes the assignment of cameras for the overloaded NVR host and/or malfunctioned NVR host. The overloaded NVR host can be prevented from breakdown and the performance of the monitoring system is not affected by the malfunctioned NVR.

According to the present invention, the system manager only needs to record the IP addresses of the NVR hosts and the profiles of the camera to the core-control module, and the core-control module can dynamically assigns one or more camera for each NVR host. The system manager can save the labor of manual setting up and memorizing the assignment between each NVR host and cameras.

Moreover, the core-control module can periodically monitors the statuses of the NVR hosts and can be immediately aware of overloaded NVR host and/or malfunctioned NVR host. Once an overloaded NVR host is found, the core-control module can dynamically assign the cameras under control of overloaded NVR host to another NVR host, thus balancing the loading in the system. Moreover, once a malfunctioned NVR host is found, the core-control module can transfer the control right of the camera, which is originally controlled by the malfunctioned NVR host, to another NVR host with normal operation. The camera originally controlled by the malfunctioned NVR host still has normal operation during the repair period of the malfunctioned NVR host.

Moreover, in the present invention, the core-control module controls all of the NVR hosts and assigns the cameras to corresponding NVR hosts. The core-control module is the only one in the system, which has public IP address; and all the NVR hosts and cameras are constructed in the same domain. This architecture can effectively reduce the risk of attack by hacker or other third party.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 and FIG. 2 respectively show the system diagram and block diagram according to a first embodiment of the present invention.

FIG. 3 shows a supplementary flowchart for the first embodiment of the present invention.

FIG. 4 shows the flowchart of camera control according to the first embodiment of the present invention.

FIG. 5 and FIG. 6 disclose a preferred solution to prevent the overload of the core-control module 1 due to complicated re-assignment process.

FIGS. 7, 8, 9 respectively show the first operation, the second operation and the third operation of load adjustment according to the present invention.

FIG. 10 shows the flowchart for handling failed NVR host.

FIGS. 11 and 12 respectively show the schematic diagrams for illustrating the first operation and the second operation for handling failed NVR host.

FIG. 13 shows the system diagram according to the second embodiment of the present invention.

FIG. 14 shows a related art monitoring system.

### DETAILED DESCRIPTION OF THE INVENTION

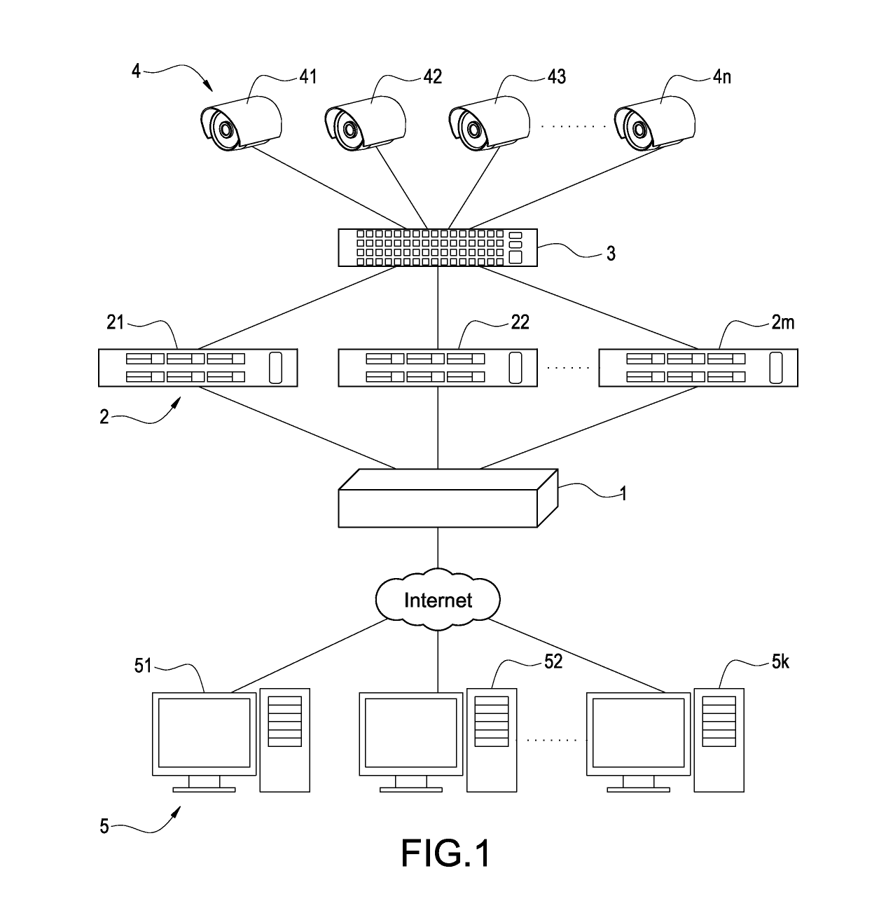

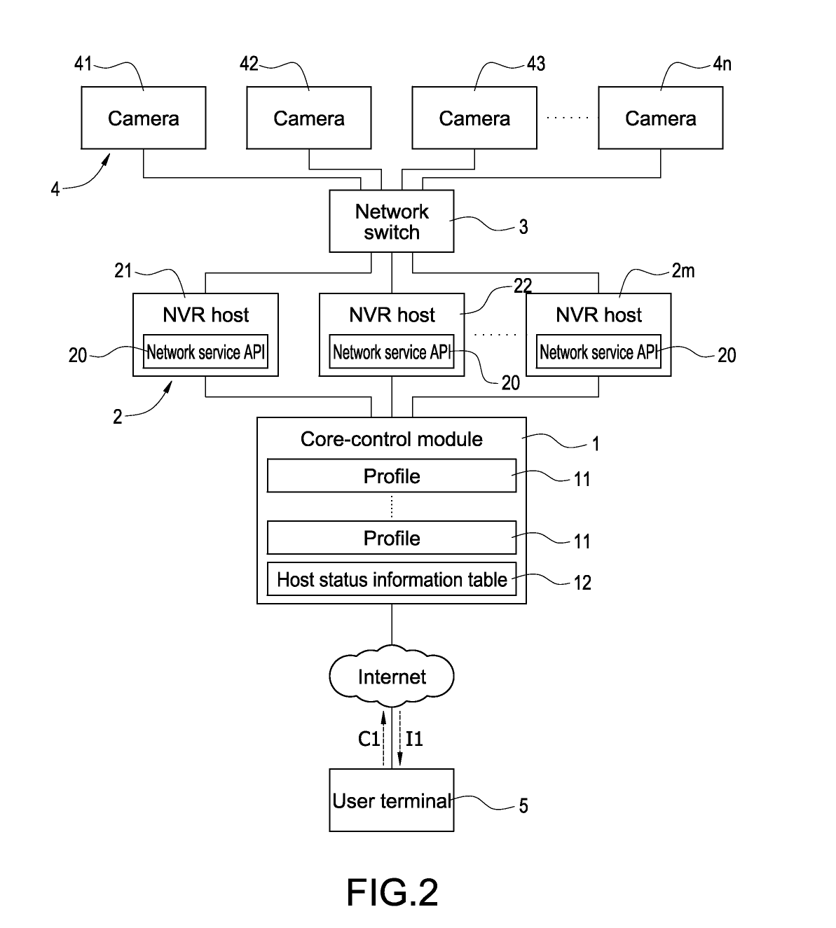

The present invention discloses a network video monitoring system (hereinafter the monitoring system), and the monitoring system mainly comprises a core-control module 1 and a plurality of network video recording (NVR) hosts 2. The NVR hosts 2 shown in FIGS. 1 and 2 are exemplified as first NVR host 21, second NVR host 22, . . . , and m-th NVR host 2m, but above example is used for illustration and is not limitation of the present invention.

The core-control module 1 and the NVR hosts 2 are established in the same domain, and more particularly the domain is, but not limited to, a private domain. In this embodiment, the NVR hosts 21-2m can be implemented by physical monitoring equipment such as computers or server, while the core-control module 1 can be a control software in any physical equipment or can be stand-alone hardware.

There is also a plurality of cameras 4 in the same domain. As shown in FIGS. 1 and 2, the cameras 4 are exemplified as first camera 41, second camera 42, . . . , and n-th camera 4n. The core-control module 1 dynamically assigns each of the cameras 41-4n to one of the NVR hosts 21-2m according to the statuses of the NVR hosts 21-2m such as loading condition, CPU using rate, disk space, available bandwidth and so on. In other word, each of the NVR hosts 21-2m is assigned to manage at least one of the cameras 41-4n. Therefore, system manager need not set up the NVR hosts 21-2m manually and need not memorize the detail of assigning cameras 41-4n to the NVR hosts 21-2m. In the embodiment, the cameras 41-4n are, for example but not limited to, IP (Internet Protocol) cameras.

Moreover, user can easily view the image of a target camera or playbacks the record of the target camera by simply sending the control command for a target camera to the core-control module 1 without the need to knowing the target camera being controlled by which one of the NVR hosts 21-2m, whereby user can view the image of a target camera or playbacks the record of the target camera.

In this embodiment, the system manager can write all of the Internet Protocol (IP) address used by the NVR hosts 21-2m into the core-control module 1. Therefore, the core-control module 1 can access the NVR hosts 21-2m by using the IP addresses stored therein and then inquire the statuses of the NVR hosts 21-2m.

As shown in FIGS. 1 and 2, the monitoring system mainly constructs the core-control module 1, the NVR hosts 21-2m, a network switch 3 and a plurality of cameras 4 in the same domain. More particularly, the network switch 3 is operatively connected to the plurality of cameras 4; the NVR hosts 21-2m are operatively connected to the network switch 3 and further operatively connected to the cameras 4 through the network switch 3. The network switch 3 can be, for example but not limited to, physically connected to the cameras 4 and the NVR hosts 21-2m through wired lines or, through wireless network protocol.

After the cameras 41-4n are constructed, the system manager records the profiles 11 of the cameras 41-4n into the core-control module 1, where the profiles 11 record the information of the cameras 41-4n such as ID, Media Access Control (Mac) Address, or accessing port numbers in the network switch 3. In the present invention, the information of the cameras 41-4n is recorded in profiles 11 by the system manager and stored in the core-control module 1, whereby the core-control module 1 can identify the cameras 4 in the same domain and then assigns the NVR hosts 2 for the cameras 4. The n cameras 41-4n can preferably have n profiles 11 respectively. However, the information of the n cameras 41-4n can also be recorded in one profile 11.

The cameras 41-4n each takes locale image and is managed by one of the NVR hosts 21-2m. For example, the first NVR host 21 can control the first camera 41 and the second camera 42 if the first camera 41 and the second camera 42 are assigned to the first NVR host 21. The control tasks include, but not limited to, simultaneous or separated movement of the first camera 41 and the second camera 42, the switch of screen color, the pixel resolution, enabling/disabling watermark, recording control and saving recorded file.

The core-control module 1 dynamically assigns the cameras 41-4n to the NVR hosts 21-2m according to the status of the NVR hosts 21-2m. In the present embodiment, one camera is only controlled by one NVR host at the same time. The core-control module 1 sends the profiles 11 of the cameras 41-4n to the corresponding NVR hosts 2 after above assignment is finished. Each of the NVR hosts 2 can know which camera(s) 4 is assigned thereto by the received one or more profile 11, and then establishes streaming image for the camera 4 under the control thereof. For example, the first NVR host 21 can know that the core-control module 1 assigns the first camera 41 and the second camera 42 to it if the first NVR host 21 receives the profiles 11 of the first camera 41 and the second camera 42 from the core-control module 1. Moreover, the second NVR host 22 can know that the core-control module 1 assigns the third camera 43 to it if the second NVR host 22 receives the profiles 11 of the third camera 43 from the core-control module 1.

As shown in FIG. 2, a network service Application Program Interface (API) 20 is executed in each of the NVR hosts 21-2m. In the present embodiment, the core-control module 1 accesses the API 20 executed in the NVR hosts 21-2m according to the IP addresses used by the NVR hosts 21-2m. Therefore the core-control module 1 can know the statuses of the NVR hosts 21-2m through inquiry and can get the replies from the NVR hosts 21-2m.

As shown in FIG. 2, the core-control module 1 further has a host status information table 12 therein. The core-control module 1 periodically inquires the status of the NVR hosts 21-2m and then updates the host status information table 12 after receiving replies from the NVR hosts 21-2m. If the assignment of the cameras 4 needs adjustment, the core-control module 1 is aware of the current status of the NVR hosts 21-2m through inquiring the host status information table 12 and then decides the adjustment of assignment for the cameras 41-4n.

For example, providing that the first NVR host 21 is assigned to control the first camera 41 and the first NVR host 21 is overloaded, the core-control module 1 can be aware of the lightest loaded m-th NVR host 2m through inquiring the host status information table 12. The core-control module 1 further transfers the control right over the first camera 41 to the NVR host 2m to reduce loading of the first NVR host 21.

In the present invention, the core-control module 1 simultaneously controls and monitors all NVR hosts 2 in the monitoring system. Therefore the monitoring system mainly constructs the core-control module 1, the NVR hosts 21-2m, a network switch 3 and a plurality of cameras 4 in the same private domain. Moreover, the core-control module 1 is connected to Internet and is functioned as exclusive outbound commination interface for the whole system (namely, only the core-control module 1 has public IP address).

As shown in FIG. 2, the monitoring system mainly connects to Internet through the core-control module 1 and connects to external user terminal 5 through Internet. As shown in FIGS. 1 and 2, the external user terminals 5 are exemplified with, but not limited to, the first external user terminal 51, the second external user terminal 52, . . . , the k-th external user terminal 5k. In this way, the NVR hosts 21-2m, the network switch 3 and the cameras 4 in the monitoring system are not in direct connection with Internet and the risk of the NVR hosts 21-2m, the network switch 3 and the cameras 4 subject to attack from Internet can be reduced.

In the present invention, the core-control module 1 can simultaneously control and monitor all NVR hosts 21-2m in the monitoring system and dynamically assign the control right over the cameras 41-4n to the NVR hosts 21-2m. More particularly, the core-control module 1 assigns the control right over the cameras 41-4n according to the loading capacities of the NVR hosts 21-2m and the quality/loading of the cameras 41-4n. The loading of the cameras 41-4n depends on the image quality such as pixel resolution, monochrome/color image, enabling/disabling watermark, and enabling/disabling dynamic detection. In other word, the NVR hosts 21-2m have heavier loading if the image quality of the cameras is more demanding.

For example, providing that each NVR host 2 has the ability to monitor 16 cameras 4 at the same time, the monitoring amount of camera is reduced to 4 or 8 when the image quality of the camera 4 is demanded to be full HD. Therefore, to dynamically assign the cameras 4 to the NVR hosts 2, several factors needs to be considers. The factors are, for example but not limited to, capacity of the NVR host 2 and the image quality of the camera 4.

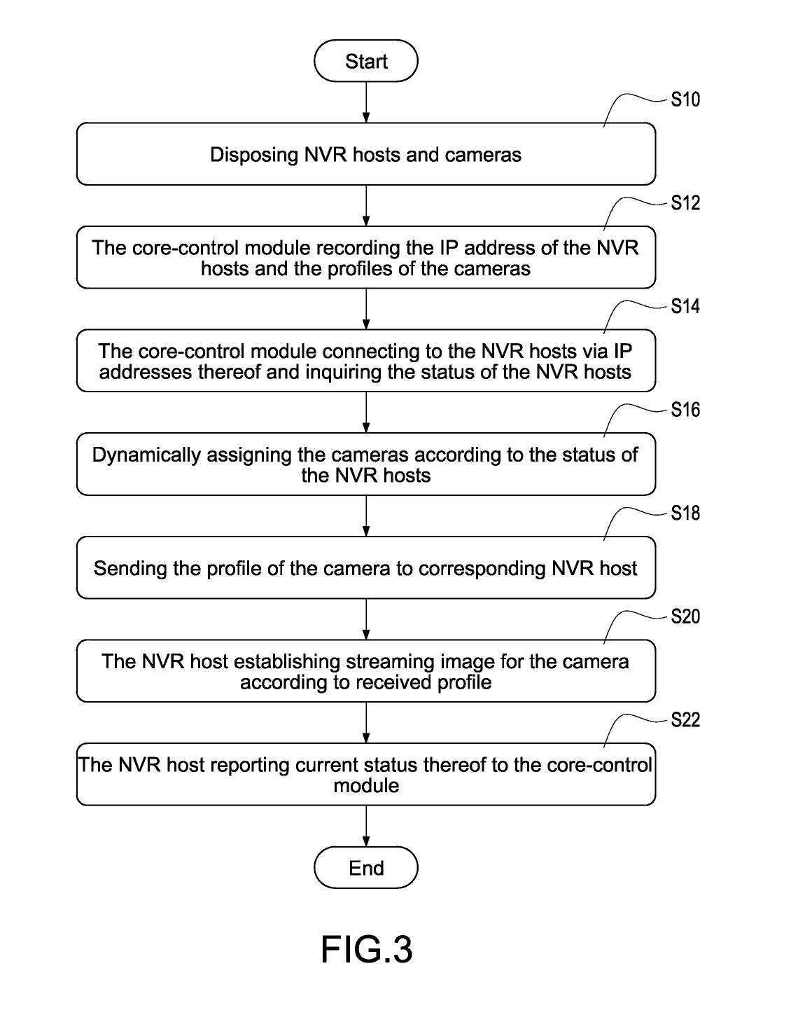

FIG. 3 shows a supplementary flowchart for the first embodiment of the present invention, the physical NVR hosts 21-2m and cameras 41-4n are disposed at suitable locations if more NVR host and camera are needed (step S10). Afterward, the system manager records the IP address of the NVR hosts 21-2m and the profiles 11 of the cameras 41-4n to the core-control module 1 (step S12). The core-control module 1 then operatively connects to the NVR hosts 21-2m according to the IP addresses stored therein and respectively inquires the status of the NVR hosts 21-2m (step S14), wherein the status of the NVR hosts 21-2m includes, but not limited to, loading, CPU using rate, hard disk space and network bandwidth of the NVR hosts 21-2m.

Afterward, the core-control module 1 dynamically assigns each of the cameras 41-4n to one of the NVR hosts 21-2m for control thereof. Depending on the assignment, each of the NVR hosts 21-2m can control one or more camera 4.

In the present embodiment, the core-control module 1 can assign the cameras 41-4n based on the image quality and loading of cameras 41-4n besides the status of the NVR hosts 21-2m. Therefore, the cameras 41-4n can be advantageously assigned to one of the NVR hosts 21-2m for optimal control thereof and the loading of the one of the NVR hosts 21-2m can be even to prevent excessively heavy or light loading of the NVR hosts 21-2m.

The core-control module 1 sends the profile 11 of each camera 41-4n to the corresponding NVR host 21, 22 or 2m to assign the camera (step S18). Therefore, based on the receiving profile, the NVR hosts 21-2m can establish streaming image for the cameras 41-4n under the control thereof (step S20). Finally, the NVR hosts 21-2m optionally report the current status to the core-control module 1 (step S22).

For example, the core-control module 1 sends the profiles 11 of the first camera 41 and the second camera 42 to the first NVR host 21 to assign the first camera 41 and the second camera 42 to the first NVR host 21, and sends the profiles 11 of the nth camera 4n to the second NVR host 22 to assign the n-th camera 4n to the second NVR host 22. The first NVR host 21 establishes streaming image for the first camera 41 and the second camera 42 after receiving the profiles for the first camera 41 and the second camera 42. The second NVR host 22 establishes streaming image for the n-th camera 4n after receiving the profile for the n-th camera 4n. After establish streaming image for cameras, the first NVR host 21 and the second NVR host 22 can respectively control the monitoring/recording of the cameras 41, 42, 4n under their control.

The first NVR host 21 and the second NVR host 22 can optionally reply their current status to the core-control module 1. The current status is for example, the loading of the first NVR host 21 after being assigned to control the first camera 41 and the second camera 42, and the loading of the second NVR host 22 after being assigned to control the n-th camera 4n.

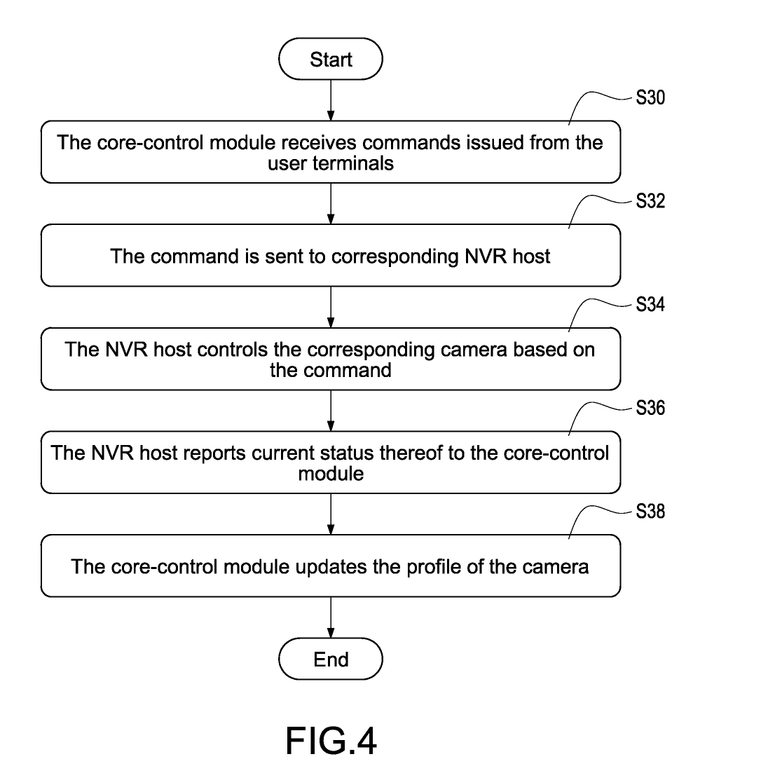

FIG. 4 shows the flowchart of camera control according to the first embodiment of the present invention. The user of the monitoring system can operate the user terminals 51-5k, through user command, to perform certain tasks such as viewing the steaming image I1 of a target camera (for example, the first camera 41), playing back the recording file of the target and controlling the target camera (such as adjusting pixel resolution, enabling/disabling dynamic detection, enabling/disabling watermark and so on). To undertake above tasks, the core-control module 1 receives commands C1 issued from the user terminals 51-5k through Internet (step S30), where the commands C1 is designated for the target camera.

Afterward, the core-control module 1 determines which NVR host (for example, the first host 21) is assigned to control the target camera, and then sends the command C1 to the NVR host assigned to the target camera (step S32). Therefore, the NVR host receiving the command C1 can perform control corresponding to the command C1 (step S34). In this embodiment, the core-control module 1 will send the command C1 designated for the first camera 41 to the first NVR host 21 such that the can control the first camera 41 corresponding to the command C1.

In this embodiment, the user can see the list of all cameras 41-4n in the monitoring system after he connect to the core-control module 1 through operating the user terminals 51-5k. The user can directly send command (designated to one of the cameras 41-4n) to the core-control module 1 without the need to identify which one of the NVR hosts 21-2m is assigned to control the target camera.

The task performed on the camera may demand to change image quality or loading of the target camera (such as switch from ordinary resolution to full HD solution) and may cause status change (such as heavier loading or reducing bandwidth) to the NVR host controlling the target camera. After step S34, the NVR host controlling the target camera can optionally report the current status thereof to the core-control module 1 (step S36). The core-control module 1 can update the host status information table 12 therein accordingly. By performing the step S36, the core-control module 1 can be aware of the updated status of the NVR hosts 21-2m by checking the host status information table 12. Therefore, the overloading of the NVR hosts 21-2m (due to the assigned control task for the cameras) or the associated failure can be prevented.

Moreover, the core-control module 1 can update the profiles 11 of the cameras 41-4n according to the content of the commands C1 (step S38). Therefore, the core-control module 1 can re-assign the cameras 41-4n according to the current status (quality and loading) of the cameras 41-4n manifested through the content of the profiles 11 if the cameras 41-4n need re-assignment.

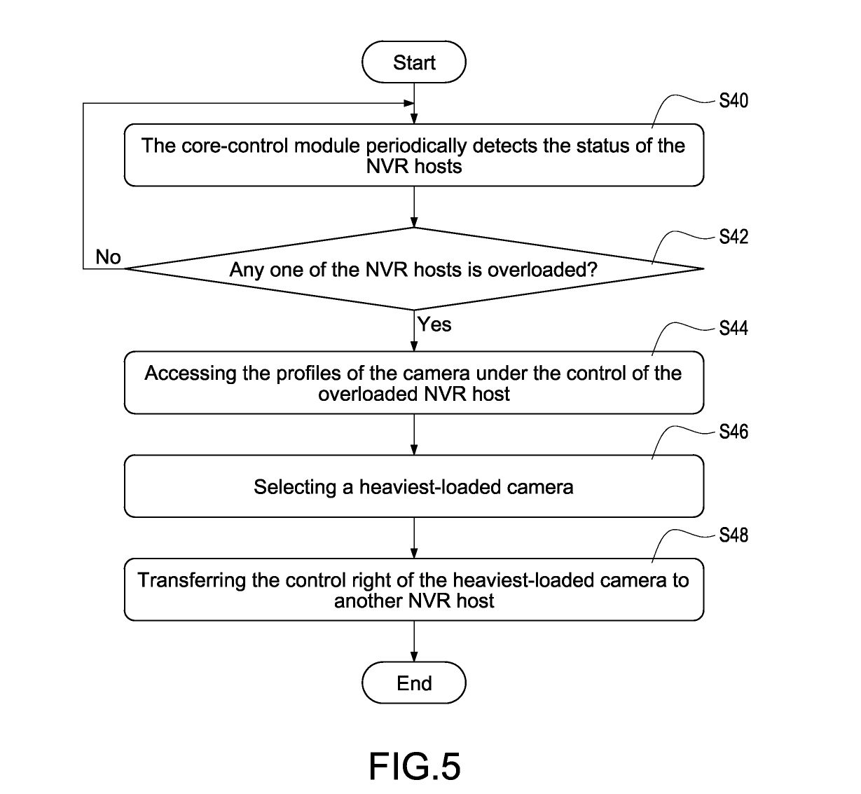

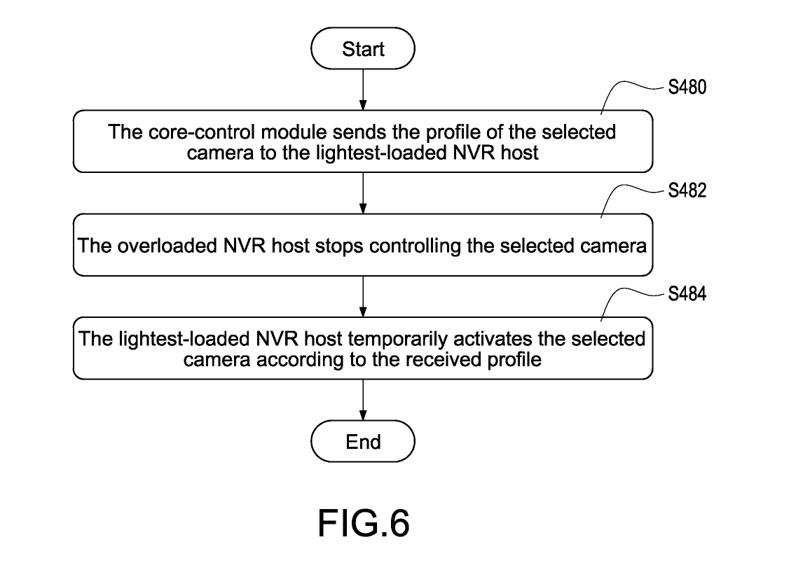

FIGS. 5 and 6 show flowchart for load adjustment and control-right transfer according to the first embodiment of the present invention. In the present invention, the core-control module 1 periodically detects the status of the NVR hosts 21-2m (step S40) and then determines whether any of the NVR hosts 21-2m has overloaded problem (step S42). The core-control module 1 can periodically send inquire to the NVR hosts 21-2m or periodically check the host status information table 12 therein to perform the detection step S40. The core-control module 1 can dynamically adjust the loading of the NVR hosts 21-2m according to the profiles once any of the NVR hosts 21-2m has overloaded problem.

For example, the core-control module 1 can select one or more camera assigned to the first NVR host 21 according to the profiles 11 of the cameras controlled by the first NVR host 21 when the first NVR host 21 is overloaded. The core-control module 1 then transfers the control right of the selected camera to at least one of other NVR hosts in the system to save the overloaded problem of the first NVR host 21.

Moreover, the core-control module 1 can re-calculate the loading of all NVR hosts 21-2m and loading of all cameras 41-4n according to the profiles 11 if any one of the NVR hosts 21-2m has loaded problem. The core-control module 1 can re-assign the cameras 41-4n to the NVR hosts 21-2m according to the calculation result, thus solving the overloaded problem for one or more NVR host in the system.

Moreover, FIGS. 5 and 6 disclose a preferred solution to prevent the overload of the core-control module 1 due to complicated re-assignment process. As shown in FIG. 5, if the core-control module 1 detects an overloaded NVR host, then the core-control module 1 accesses the profiles 11 of all cameras under the control of the overloaded NVR host (step S44). The core-control module 1 selects a heaviest-loaded camera among the cameras under the control of the overloaded NVR host according to the accessed profiles 11 (step S46). Afterward, the core-control module 1 transfers the control right of the heaviest-loaded camera to another NVR host (step S48). More particular, in step S48, the core-control module 1 preferably selects a lightest-loaded NVR host among all the NVR hosts and then transfers the control right of the heaviest-loaded camera to the lightest-loaded NVR host.

More substantially, the core-control module 1 periodically sends inquire to the NVR hosts 21-2m or periodically checks the host status information table 12 therein to identify the lightest-loaded NVR host among all the NVR hosts and then transfers the control right of the heaviest-loaded camera to the lightest-loaded NVR host. Therefore, the problem of the overloaded NVR host can be solved while the NVR host transferred with the control right is least liable to have overload problem.

In this embodiment, the above mentioned step S48 is realized by the flowchart shown in FIG. 6. Firstly, the camera to be re-assigned is selected and then the core-control module 1 sends the profile of the selected camera to the lightest-loaded NVR host (step S480). The overloaded NVR host stops controlling the selected camera (step S482) and then the lightest-loaded NVR host temporarily activates the selected camera according to the received profile (step S484). The load adjustment process mentioned in FIG. 5 is described with an illustrated example.

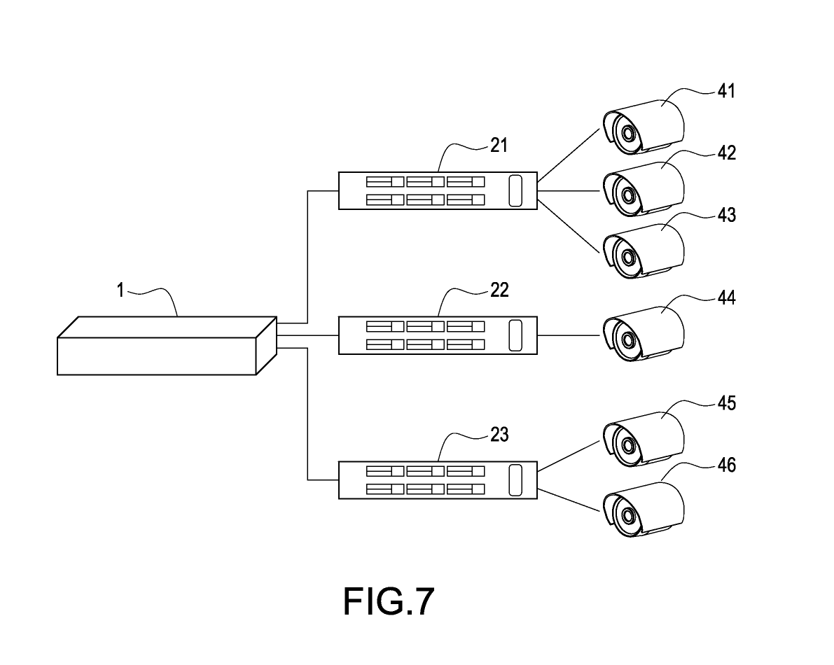

FIGS. 7, 8, 9 respectively show the first operation, the second operation and the third operation of load adjustment according to the present invention. As shown in FIG. 7, the monitoring system is assumed to have the core-control module 1, three NVR hosts 2, and six cameras 4, wherein the three NVR hosts 2 includes the first NVR host 21, the second NVR host 22 and the third NVR host 23 operatively connected to the core-control module 1. The first NVR host 21 controls the first camera 41, the second camera 42 and the third camera 43. The second NVR host controls the fourth camera. The third NVR host 23 controls the fifth camera 45 and the sixth camera 46.

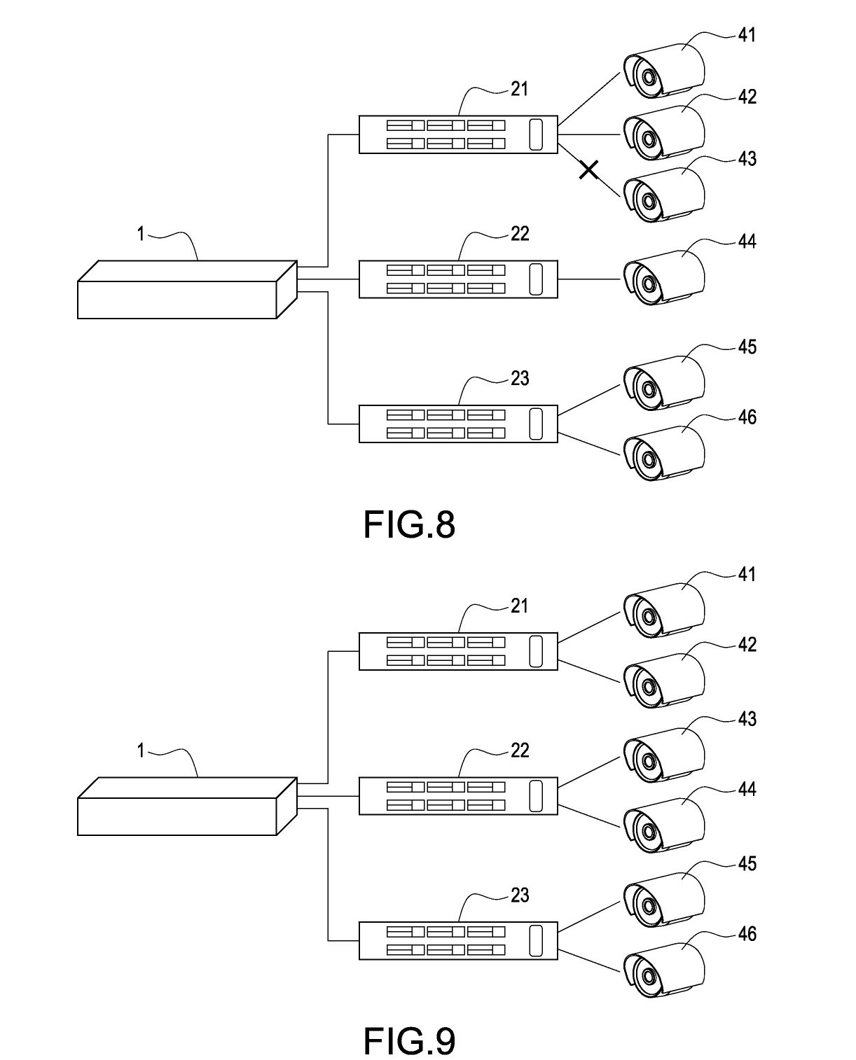

As shown in FIG. 8, the core-control module 1 will dynamically adjust the first camera 41, the second camera 42 and the third camera 43 controlled by the first NVR host 21 if the core-control module 1 detects that the first NVR host 21 is overloaded. At first, the core-control module 1 accesses the profiles of the first camera 41, the second camera 42 and the third camera 43 and then finds that the third camera 43 has higher loading (for example, the image resolution of the third camera 43 is higher than that of the first camera 41 and the second camera 42). Therefore, the core-control module 1 issues command to the first NVR host 21 to stop controlling the third camera 43 to reduce the load of the first NVR host 21.

As shown in FIG. 9, the core-control module 1 then sends inquiries to the second NVR host 22 and the third NVR host 23 (or checks the host status information table 12) and finds that the second NVR host 22 has lightest load in the system. Therefore, the core-control module 1 sends the profile 11 of the third camera 43 to the second NVR host 22. The second NVR host 22 temporarily activates the third camera 43 according to the received profile 11, thus undertaking the control for the third camera 43.

In this embodiment, the second NVR host 22 temporarily activates the third camera 43 and then transfers the control right of the third camera 43 to the first NVR host 21 if the overload problem of the first NVR host 21 is solved. According to another embodiment, the second NVR host 22 can completely take over the control of the third camera 4. The core-control module 1 determines whether the cameras 43 and 44 controlled by the second NVR host 22 need adjustments if the second NVR host 22 also encounters overload problem.

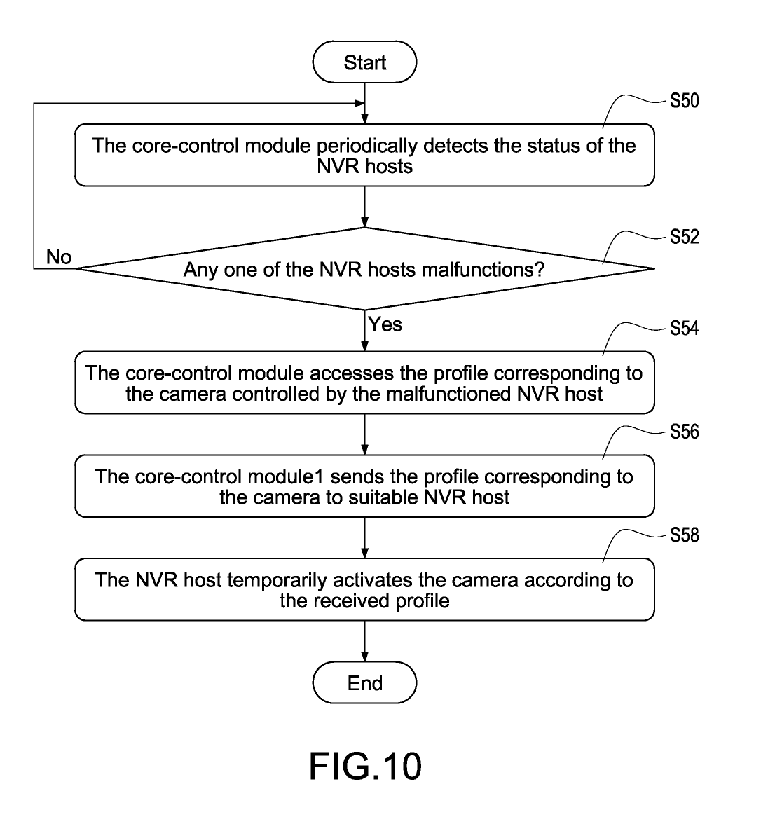

FIG. 10 shows the flowchart for handling failed NVR host. The core-control module 1 periodically detects the status of the NVR hosts 21-2m (step S50) and the core-control module 1 further detects whether any one of the NVR hosts 21-2m fails besides detecting overloaded NVR host (step S52).

When the core-control module 1 finds a failed NVR host and the failed NVR host is assigned to control one or more camera, then the core-control module 1 accesses the profiles corresponding to the one or more camera controlled by the failed NVR host 2 (step S54). The core-control module 1 sends the profiles corresponding to the one or more camera controlled by the failed NVR host 2 to at least one normally-operating NVR host 2 according to the status of the normally-operating NVR host 2 (step S56). In above step S56, the core-control module 1 can periodically send inquires for status of the normally-operating NVR hosts 2, or directly check the status of the normally-operating NVR hosts 2 by accessing the host status information table 12.

The normally-operating NVR hosts 2 can temporarily activate the cameras 4 corresponding to the profiles 11 sent thereto (step S58). Therefore, the control right over the camera is transferred from the failed NVR host and to the normally-operating NVR hosts 2. The cameras 4 originally controlled by the failed NVR host can still have normal operation during the fixing period of the failed NVR host. The process for handling failed NVR host in FIG. 10 is further detailed with following example.

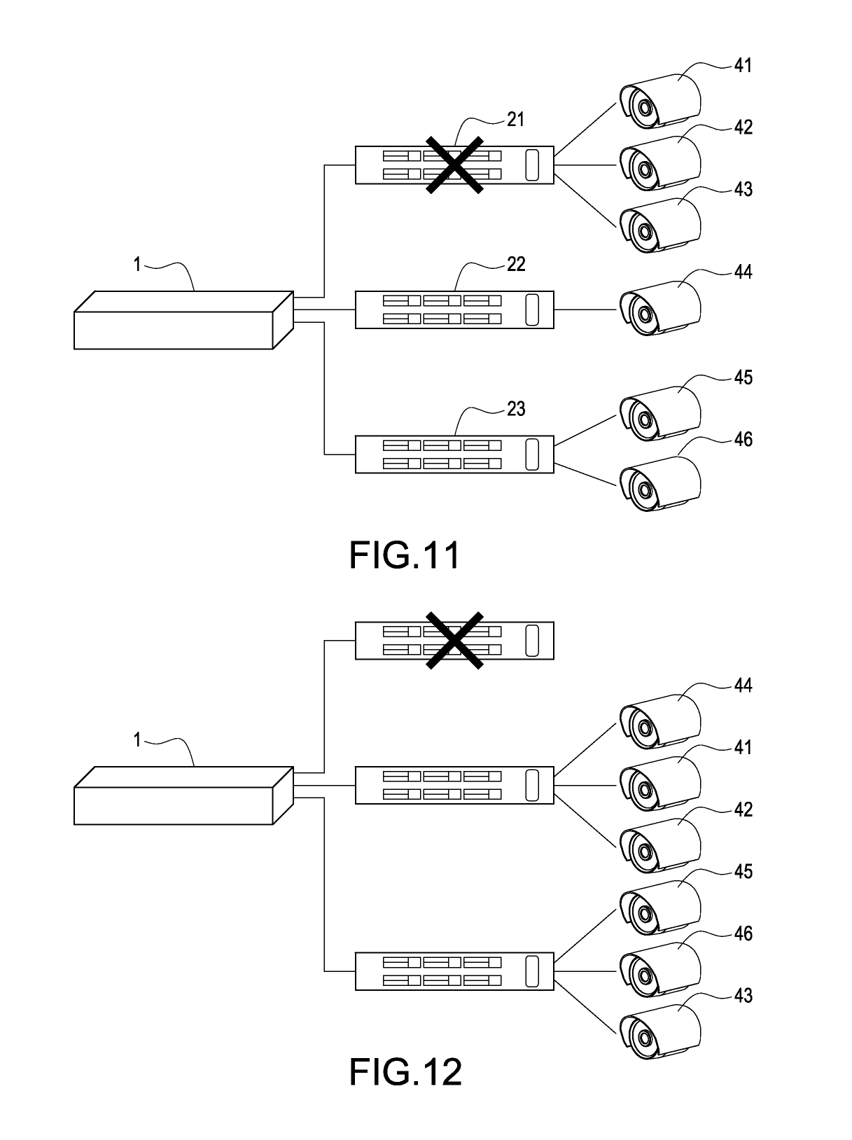

FIGS. 11 and 12 respectively show the schematic diagrams for illustrating the first operation and the second operation for handling failed NVR host. As shown in FIG. 11, if the core-control module 1 detects that the first NVR host 21 malfunctions, then the core-control module 1 accesses the profiles 11 of the first camera 41, the second camera 42 and the third camera 43 under the control of the first NVR host 21 (namely, three profiles 11 are needed to be accessed). The core-control module 1 then finds other NVR hosts which are normally-operated (namely, the second NVR host 22 and the third NVR host 23 in the example) through directly inquiring other NVR hosts or checking the host status information table 12. Finally, the core-control module 1 dynamically transfers the control rights of the first camera 41, the second camera 42 and the third camera 43 to the second NVR host 22 and/or the third NVR host 23, depending on the status of the second NVR host 22 and the third NVR host 23.

In this example, the control right for the first camera 41 and the second camera 42 is transferred to the second NVR host 22, and the control right for the third camera 43 is transferred to the third NVR host 23. Therefore, the first camera 41, the second camera 42 and the third camera 43 can continue monitoring/recording operation even though the first NVR host 21 malfunctions. Moreover, the core-control module 1 has ensured the status of the second NVR host 22 and the third NVR host 23 before re-assigning the first camera 41, the second camera 42 and the third camera 43 such that the second NVR host 22 and the third NVR host 23 are not overloaded after the transfer.

In the present invention, the core-control module 1 can be implemented by software to fulfill above mentioned operation. The core-control module 1 is exemplified with a standalone unit (not shown). Moreover, the core-control module 1 can be integrated with one of the NVR hosts 2 to reduce cost.

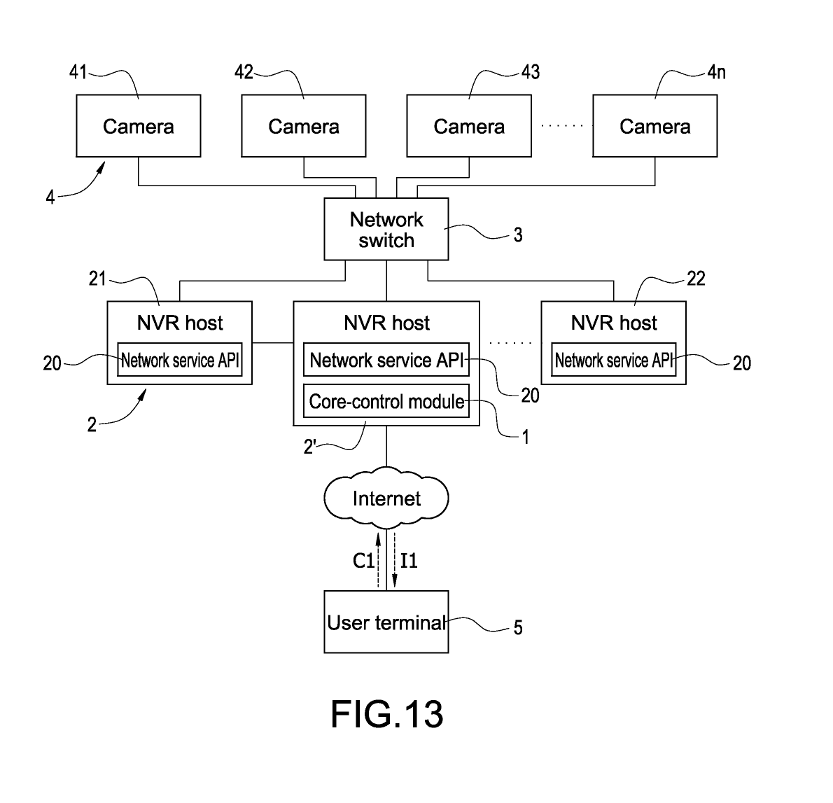

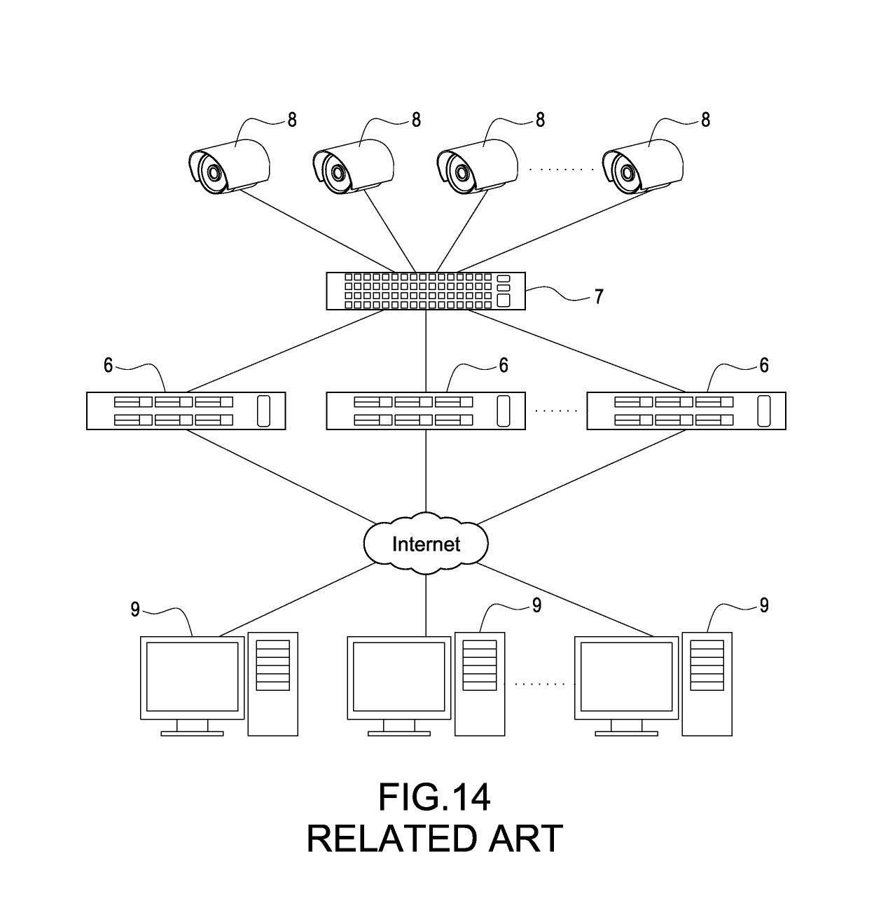

FIG. 13 shows the system diagram according to the second embodiment of the present invention. The system shown in FIG. 13 is similar to that shown in FIG. 2 except that one NVR host 2′ in FIG. 13 is further installed with the core-control module 1 while other NVR hosts (such as the first NVR host 21 and the second NVR host 22) are not. Therefore, the other NVR hosts 21 and 22 are operatively connected to the NVR host 2′ installed with the core-control module 1 and communicates with the core-control module 1. Moreover, the NVR host 2′ is operatively connected to both private domain and Internet such that the NVR host 2′ is operatively connected to the other NVR hosts 21 and 22, the network switch 3, and the cameras 41-4n through private domain, and connected to the user terminals 5 through Internet.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A network video monitoring system comprising:
a plurality of network video recording (NVR) hosts configured to control a plurality of cameras, each NVR host controlling at least one camera; and
a core-control module placed within a same domain with the NVR hosts, the core-control module configured to store internet protocol (IP) addresses of the NVR hosts and operatively connect to the NVR host through the stored IP addresses,
wherein the core-control module is configured to inquire a status of each NVR host and assign the camera in the same domain to the NVR hosts according to the statuses of the NVR hosts, thus controlling the cameras by the corresponding NVR hosts.

2. The network video monitoring system in claim 1, wherein the core-control module is configured to store a profile for each camera and to send the profile of the camera to a corresponding NVR host, each NVR host establishing at least one streaming image for the camera under the control thereof according to a received profile, wherein each profile is stored with an ID for the camera.

3. The network video monitoring system in claim 2, wherein the core-control module is configured to periodically inquire the status of each NVR host and receive a reply from the inquired NVR host, thus updating a host status information table therein.

4. The network video monitoring system in claim 3, wherein each NVR host further comprises a network service application program interface (API), the core-control module accesses the network service API of each NVR host according to IP address of the NVR host to inquire the status of the NVR host.

5. The network video monitoring system in claim 1, wherein the core-control module, the plurality of NVR hosts, the network switch and the cameras are disposed in a private domain, the core-control module is operatively connected to Internet and further operatively connected to a user terminal through Internet.

6. The network video monitoring system in claim 1, wherein the core-control module receives a command sent from an external user interface and designated to a target camera, the core-control module sends the command to the NVR host assign to control the target camera, wherein the NVR host controlling the target camera according to the received command and the core-control module updates the profile for the target camera according to the command.

7. The network video monitoring system in claim 6, wherein the core-control module is configured to dynamically adjust loading of the NVR hosts according to the profiles of the cameras.

8. The network video monitoring system in claim 7, wherein the core-control module is configured to select a heaviest-loaded camera controlled by an overloaded NVR host according to the profiles when the core-control module detects the overloaded NVR host, the core-control module transfers a control right of the heaviest-loaded camera to a lightest-loaded NVR host in the system for further control.

9. The network video monitoring system in claim 7, wherein the core-control module is configured to detect a malfunctioned NVR host and respectively transfer control rights of all cameras controlled by the malfunctioned NVR host to other normally operated NVR hosts.

10. The network video monitoring system in claim 1, wherein the core-control module is installed in one of the NVR hosts.

11. A method for automatically assigning cameras for a network video monitoring system, the network video monitoring system comprising a core-control module, a plurality of network video recording (NVR) hosts and a plurality of cameras, the method comprising:
a) the core-control module recording IP addresses of all NVR hosts;
b) the core-control module operatively connecting to the NVR hosts according to the IP addresses recorded therein;
c) the core-control module inquiring statuses of the NVR hosts; and
d) assigning the cameras to the NVR hosts according to statuses of the NVR hosts.

12. The method in claim 11, wherein the core-control module also stores profiles of the cameras, the step d further comprises:
d1) the core-control module sending the profiles of the cameras to corresponding NVR hosts;
d2) each NVR host establishing at least one streaming image for at least one camera under the control thereof according to the received profile;
d3) each NVR host reporting a current status thereof to the core-control module.

13. The method in claim 12, wherein the core-control module is further operatively connected to an external user terminal, the method further comprising:
e) the core-control module receives a command issued from the user interface and designated to a target camera;
f) sending the command to a NVR host assigned to control the target camera;
g) the NVR host control the target according to the command;
h) after step g, the NVR host reporting a current status thereof to the core-control module; and
i) the core-control module updating the profile of the target camera according to the command.

14. The method in claim 12, further comprising a step j:
the core-control module dynamically adjusting load of the NVR hosts according to the profiles.

15. The method in claim 14, wherein the step j further comprises:
j1) the core-control module detecting statuses of the NVR hosts;
j2) determining whether an overloaded NVR host or a malfunctioned NVR host is present;
j3) accessing the profiles of the cameras controlled by the overloaded NVR host;
j4) after step j3, selecting a heaviest-loaded camera from the cameras controlled by the overloaded NVR host;
j5) transferring a control right of the selected camera to a lightest-loaded NVR host in the system;
j6) accessing the profiles of the cameras controlled by the malfunctioned NVR host; and
j7) after step j5, respectively sending the profiles of the cameras controlled by the malfunctioned NVR host to normally-operated NVR hosts to transfer the control rights of the cameras controlled by the malfunctioned NVR host to the normally-operated NVR hosts.

16. The method in claim 15, wherein the step j5 further comprises:
j51) the core-control module sending the profile of the selected camera to the lightest-loaded NVR host in the system;
j52) the overloaded NVR host stopping controlling the selected camera; and
j53) the lightest-loaded NVR host temporarily activating the selected camera according to the received profile.

17. A network video monitoring system comprising:
a plurality of camera;
a network switch operatively connected to the cameras;
a plurality of network video recording (NVR) operatively connected to the network switch and operatively connected to the cameras through the network switch; and
a core-control module recording IP addresses of the NVR hosts and a profile for each camera, the core-control module operatively connected to the NVR hosts through the IP addresses,
wherein the core-control module is configured to inquire a status of each NVR host and send the profile of each camera to a corresponding NVR host, whereby each NVR host establishes a streaming image for at least one camera under the control thereof according to the received profile.

18. The network video monitoring system in claim 17, wherein the core-control module, the NVR hosts, the network switch and the cameras are constructed in a private domain, the core-control module is operatively connected to Internet and receives a command sent from a user interface through Internet and designated to a target camera, the core-control module sends streaming image of the target camera to the user interface.

19. The network video monitoring system in claim 18, wherein the core-control module dynamically balances the load of the NVR hosts according to the profiles.

20. The network video monitoring system in claim 19, wherein the core-control module selects a heaviest-loaded camera from the cameras controlled by an overloaded NVR host according to the profiles, the core-control module transfers a control right of the selected camera to a lightest-loaded NVR host in the system; wherein the core-control module respectively sends the profiles of the cameras controlled by a malfunctioned NVR host to normally-operated NVR hosts to transfer the control rights of the cameras controlled by the malfunctioned NVR host to the normally-operated NVR hosts.
